(19) United States
(12) Patent Application Publication
(10) Pub. No.: US 2007/0283294 A1
(43) Pub. Date: Dec. 6, 2007

(54) Content reproducing method

(75) Inventors: Hitoshi Tanohka, Osaka (JP); Megumi Kondo, Osaka (JP); Yasuhiro Yukita, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial, Kadoma-shi (JP)

(21) Appl. No.: 11/785,704

(22) Filed: Apr. 19, 2007

(30) Foreign Application Priority Data
Apr. 28, 2006 (JP) 2006-124566

(51) Int. Cl. G06F 3/048

(52) U.S. Cl. 715/840

(57) ABSTRACT

According to a content reproducing method, when contents are from a recording medium, one of the presence or absence of menu contents and a title indicating the body of the contents is analyzed, and some of necessary key operations are automatically performed according to the contents of the analysis to reproduce the contents, in the case where menu contents are present and a plurality of buttons are provided to reproduce contents other than menu contents when the buttons of a menu are pressed, contents reproduced by executing one button having the smallest number are reproduced as a main part. The number uniquely distinguishes the button from the other buttons.

### FIELD OF THE INVENTION

The present invention relates to a method of reproducing contents in a reproducing apparatus, the contents including, for example, images and audio data recorded on a recording medium such as an optical disc and a hard disk.

### BACKGROUND OF THE INVENTION

In recent years, electronic equipment has various useful functions. By operating keys on main bodies or remote controls, users can cause equipment to perform equipment operations corresponding to a purpose, that is, operational functions.

However, as the number of operational functions increases, key operations may become complicated and a number of key operations may be necessary before a user reaches an originally desired function.

When a number of key operations are necessary, a user generally operates keys while reading an operation manual. Without reading an operation manual, the user may perform excessive key operations or erroneous key operations and thus may not reach a desired function, so that the user may feel dissatisfied with the equipment.

Therefore, in order to overcome the dissatisfaction of users, simple operations and operation assistance have been demanded.

Conventionally, operations have been simplified and the load of operating keys on main bodies and remote controls has been reduced, not in reproducing apparatuses for contents such as images and audio data but in electronic equipment such as an amplifier (for example, see Japanese Patent Laid-Open No. 7-57442).

The above proposed configuration includes a control circuit for switching operations in response to an operation of a remote control key upon startup. The operations of an overall apparatus are switched in response to an operation of the remote control key and some operations from a remote control are not accepted, thereby eliminating the complexity of the operations.

For example, some operations of the remote control and the like are not accepted, so that a user does not have to perform unnecessary operations during normal use. For example, once the initialization of equipment is completed, operations such as selection in the initialization are not necessary thereafter. Further, it is possible to limit functions used almost only by advanced level users. For example, special playback operations including slow motion playback and frame-by-frame playback can be limited.

According to this configuration, in order to reduce the complexity of operations, switching to a single operating state can be performed by a remote control operation. However, under some conditions of use, the switching to a single operating state may disable operations desired by a user because of different levels of complexity of the desired operations, so that the convenience may decrease. Another demerit is that a restriction on key operations uniformly limits functions performed by a user. Further, in the case where switching is disabled after an input on the remote control is restricted only once upon startup, when the operating state changes and the original key input becomes necessary during an operation, a user cannot perform the subsequent operation.

### DISCLOSURE OF THE INVENTION

It is an object of the present invention to provide a content reproducing method for simplifying operations by selecting operation modes and simultaneously preventing convenience of users from decreasing.

In order to attain the object, the present invention is a method of reproducing contents recorded on a recording medium,

in a contents reproducing apparatus having, as operation modes, at least a normal operation mode enabling all the operations and a simplified operation mode enabling a control unit to automatically perform key operations required during reproduction, the contents reproducing apparatus eliminating key operations from a body key operation part and a remote key operation part according to predetermined operations corresponding to the selected operation mode,

when the control unit reads the contents from the recording medium, analyzes one of the presence or absence of menu contents and a title indicating the body of the contents, and automatically performs some of necessary key operations according to the contents of the analysis to reproduce the contents,

menu contents are present and contents corresponding to buttons assigned to reproduce contents other than menu contents are reproduced as a main part when the buttons of a menu are pressed.

The following is the detail of the present invention.

The present invention is a method of reproducing contents recorded on a recording medium,

in a contents reproducing apparatus including: a data reading section for reading data of contents from the recording medium; a data processing section for performing predetermined processing on the data read by the data reading section; a control unit for controlling at least the data reading section and the data processing section through a control bus; a body key operation part for directly selecting a predetermined reproducing operation and an operation mode through the control unit; a remote key operation part for remotely selecting a predetermined reproducing operation and an operation mode through the control unit; and a storage section connected to the control unit to store a control program and information on the selected operation mode, the operation mode including at least a normal operation mode enabling all the operations and a simplified operation mode enabling the control unit to automatically perform key operations required during reproduction, the control unit eliminating key operations from the operation parts according to predetermined operations corresponding to the selected operation mode,

when the control unit reads the contents from the recording medium, analyzes one of the presence or absence of menu contents and a title indicating the body of the contents, and automatically performs some of necessary key operations according to the contents of the analysis to reproduce the contents,

menu contents are present and contents corresponding to buttons assigned to reproduce contents other than menu contents are reproduced as a main part when the buttons of a menu are pressed.

When a plurality of buttons are provided to reproduce contents other than menu contents, contents reproduced by executing one button having the smallest number are reproduced as a main part, out of the buttons identified by numbers.

When a plurality of buttons are provided to reproduce contents other than menu contents, contents reproduced by executing one button automatically executed after a certain period of time are reproduced as a main part.

When a plurality of buttons are provided to reproduce contents other than menu contents, contents reproduced by executing one button where a cursor is placed upon the display of the menu are reproduced as a main part.

When a plurality of buttons are provided to reproduce contents other than menu contents and the buttons include a button automatically executed after a certain period of time and a button where a cursor is placed upon the display of the menu, contents reproduced by the button automatically executed after a certain period of time are reproduced as a main part.

When a plurality of buttons are provided to reproduce contents other than menu contents and the buttons include a button automatically executed after a certain period of time and a button where a cursor is placed upon the display of the menu, contents reproduced by executing the button where the cursor is placed upon the display of the menu are reproduced as a main part.

When a plurality of buttons are provided to reproduce contents other than menu contents and the buttons do not include a button automatically executed after a certain period of time and a button where a cursor is placed upon the display of the menu, contents reproduced by executing one button having the smallest number are reproduced as a main part, out of the buttons identified by numbers.

Another aspect of the present invention is a method of reproducing contents recorded on a recording medium,

in a contents reproducing apparatus having, as operation modes, at least a normal operation mode enabling all the operations and a simplified operation mode enabling a control unit to automatically perform key operations required during reproduction, the contents reproducing apparatus eliminating key operations from a body key operation part and a remote key operation part according to predetermined operations corresponding to the selected operation mode,

when the control unit reads the contents from the recording medium, analyzes one of the presence or absence of menu contents and a title indicating the body of the contents, and automatically performs some of necessary key operations according to the contents of the analysis to reproduce the contents,

in the case where menu contents are present and contents reproduced by pressing the buttons of a menu are all menu contents, contents corresponding to buttons assigned to reproduce title contents without user operations are reproduced as a main part during the reproduction of the menu contents reproduced by pressing the buttons.

The following is the detail of this invention.

This invention is a method of reproducing contents recorded on a recording medium,

in a contents reproducing apparatus including: a data reading section for reading data of contents from the recording medium; a data processing section for performing predetermined processing on the data read by the data reading section; a control unit for controlling at least the data reading section and the data processing section through a control bus; a body key operation part for directly selecting a predetermined reproducing operation and an operation mode through the control unit; a remote key operation part for remotely selecting a predetermined reproducing operation and an operation mode through the control unit; and a storage section connected to the control unit to store a control program and information on the selected operation mode, the operation mode including at least a normal operation mode enabling all the operations and a simplified operation mode enabling the control unit to automatically perform key operations required during reproduction, the control unit eliminating key operations from the operation parts according to predetermined operations corresponding to the selected operation mode,

when the control unit reads the contents from the recording medium, analyzes one of the presence or absence of menu contents and a title indicating the body of the contents, and automatically performs some of necessary key operations according to the contents of the analysis to reproduce the contents,

in the case where menu contents are present and contents reproduced by pressing the buttons of a menu are all menu contents, contents corresponding to buttons assigned to reproduce title contents without user operations are reproduced as a main part during the reproduction of the menu contents reproduced by pressing the buttons.

According to the content reproducing methods, a user can select a usable key in response to the operation mode and the control unit can determine a usable key according to contents. Thus it is possible to perform, for example, key operations corresponding to the skill of the user, achieving simple operations and enhanced convenience.

When contents are read from a recording medium to analyze one of the presence or absence of menu contents and the title of the body of the contents and some of necessary key operations are automatically performed according to the contents of the analysis to reproduce the contents, even in the presence of menu contents and the subsequent menu contents, regarding buttons corresponding to contents other than the subsequent menu contents, the contents corresponding to the buttons are automatically reproduced as a main part. Thus even when the menu has at least two stages, the body of the contents can be reliably reproduced.

Other features and effects of the present invention will become more apparent in preferred embodiments described with reference to the accompanying drawings.

### BRIEF DESCRIPTION OF THE DRAWINGS

FIG. 1 schematically shows the overall configuration of a contents reproduction system using a contents reproducing apparatus according to First Embodiment of the present invention;

FIG. 2 is a block diagram schematically showing the configuration of a contents reproducing apparatus according to First Embodiment of the present invention;

FIG. 3 shows operation modes selectable in the contents reproducing apparatus;

FIG. 4 is a flowchart showing steps of deciding the presence or absence of menu contents in the contents reproducing apparatus;

FIG. 5 is a flowchart showing steps of deciding the presence or absence of menu contents during the reproduction of an optical disc in the contents reproducing apparatus;

FIG. 6A is a flowchart showing the reproduction of the optical disc in the contents reproducing apparatus;

FIG. 6B is a flowchart showing the reproduction of the optical disc in the contents reproducing apparatus;

FIG. 7 shows the configuration of video, title and set, in the optical disc;

FIG. 8A is a flowchart showing the reproduction of an optical disc in a content reproducing method according to Second Embodiment of the present invention;

FIG. 8B is a flowchart showing the reproduction of the optical disc in the content reproducing method;

FIG. 9A is a flowchart showing the reproduction of an optical disc in a content reproducing method according to Third Embodiment of the present invention;

FIG. 9B is a flowchart showing the reproduction of the optical disc in the content reproducing method;

FIG. 10A is a flowchart showing the reproduction of an optical disc in a content reproducing method according to Fourth Embodiment of the present invention;

FIG. 10B is a flowchart showing the reproduction of the optical disc in the content reproducing method;

FIG. 11A is a flowchart showing the reproduction of an optical disc in a content reproducing method according to Fifth Embodiment of the present invention;

FIG. 11B is a flowchart showing the reproduction of the optical disc in the content reproducing method;

FIG. 12A is a flowchart showing the reproduction of an optical disc in a content reproducing method according to Sixth Embodiment of the present invention; and

FIG. 12B is a flowchart showing the reproduction of the optical disc in the content reproducing method.

### DESCRIPTION OF THE EMBODIMENTS

Content reproducing methods according to preferred embodiments of the present invention will now be described with reference to the accompanying drawings.

### First Embodiment

A content reproducing method according to First Embodiment of the present invention will be described below with reference to the accompanying drawings (corresponding to claims 1 and 2).

First, the following will discuss a contents reproducing apparatus for implementing the content reproducing method and a contents reproduction system using the contents reproducing apparatus.

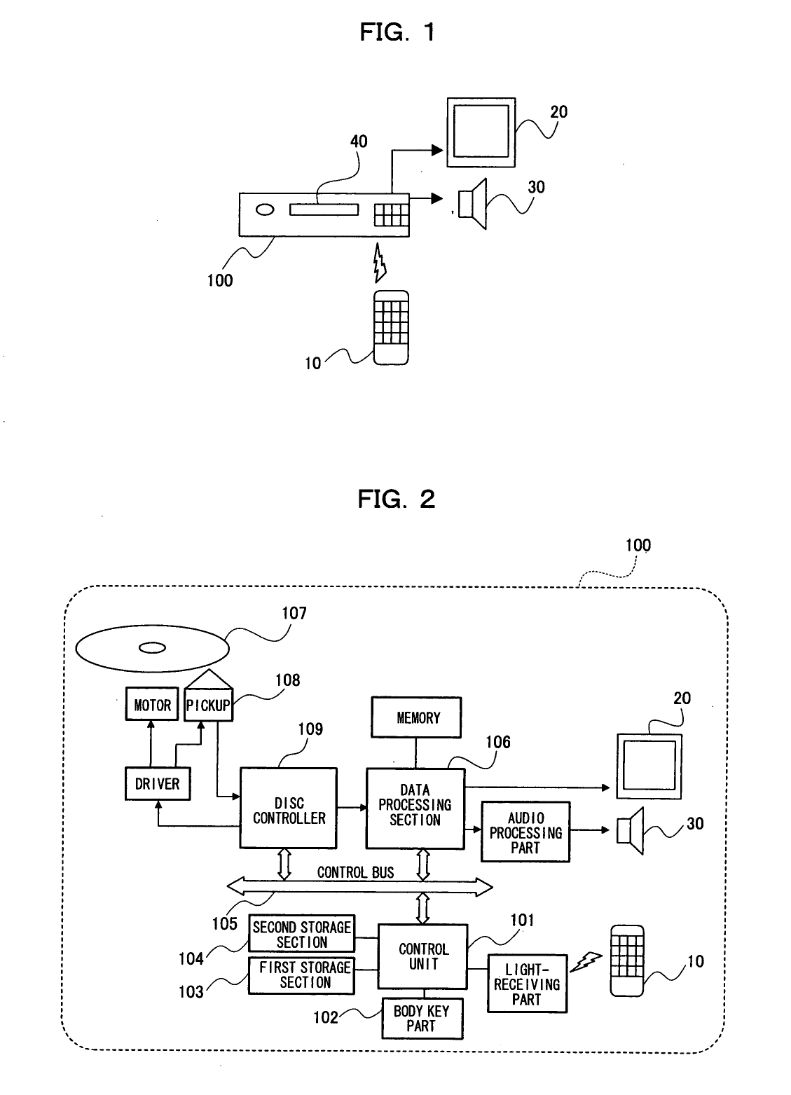

FIG. 1 schematically shows the overall configuration of the contents reproduction system using the contents reproducing apparatus. FIG. 2 is a block diagram showing the internal configuration of the contents reproducing apparatus.

As shown in FIG. 1, a contents reproducing apparatus (hereinafter, simply referred to as a reproducing apparatus) 100 is provided to reproduce contents such as video data and audio data recorded on an optical disc (an example of a recording medium, specifically including a DVD disc). Naturally, reproduced data is transmitted to a display device 20 such as a monitor and speakers 30, so that the contents can be appreciated.

On an optical disc (hereinafter, simply referred to as a disc) 107 such as a DVD, as a matter of course, menu contents are recorded to efficiently display and reproduce recorded contents and the bodies of the contents are respectively recorded with predetermined titles.

As shown in FIG. 2, the contents reproducing apparatus 100 includes a control unit (for example, a CPU) 101 for controlling the overall apparatus, a body key part (body key operation part) 102 directly connected to the control unit 101, a first storage section (ROM serving as a nonvolatile memory) 103 connected to the control unit 101 to store a program for operating the control unit 101, a second storage section (RAM) 104 for storing variables such as an operating state, and a data processing section 106 connected to the control unit 101 via a control bus 105 to perform predetermined processing (for example, decoding) on video and audio data. Video data and audio data obtained in the data processing section 106 are outputted to the display device 20 and the speakers 30.

The reproducing apparatus 100 further includes a remote control key part (remote key operation part) 10 for enabling a user to remotely operate the reproducing apparatus 100.

When the disc 107 is loaded into a disc tray 40 of the reproducing apparatus 100, video data and audio data are read through a pickup 108 provided in the reproducing apparatus 100 and the data is transmitted to the data processing section 106 through a disc controller 109. The pickup 108, the disc controller 109 and so on make up a data reading section.

In the reproducing apparatus 100, when the user selects an operation mode by remote control, the contents are analyzed in the control unit 101 and thus switching of operation modes is notified from the remote control key part 10. The selected operation mode is stored in the second storage section 104.

After that, in response to the operation mode stored in the second storage section 104, the control unit 101 controls the operations of the overall apparatus and the control unit 101 limits the acceptance of key inputs from the remote control key part 10 and the body key part 102.

Further, the control unit 101 reads video data and audio data serving as the bodies of the contents from the disc 107 through the disc controller 109, performs data analysis on the read contents, and controls the overall apparatus based on the analysis results.

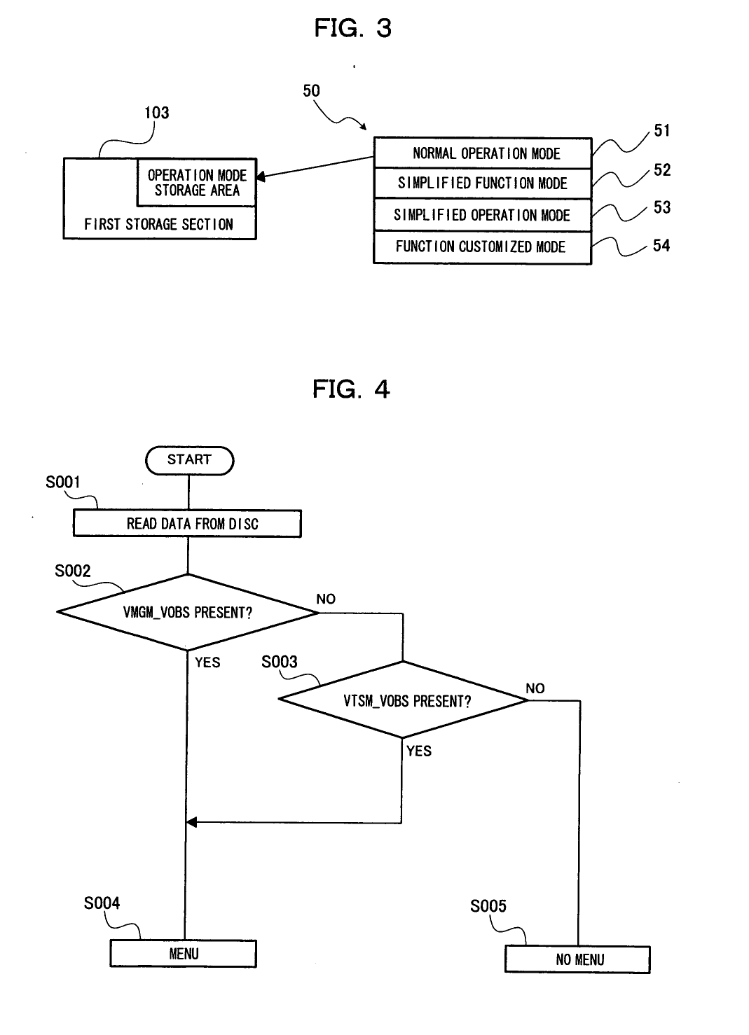

FIG. 3 shows the contents of a selectable operation mode 50 in the reproducing apparatus 100.

To be specific, the operation mode includes a normal operation mode 51, a simplified function mode 52, a simplified operation mode 53, and a function customized mode 54. Information in these modes is stored in an operation mode storage area provided in the first storage section 103.

The following will discuss the information in these operation modes.

In the normal operation mode 51, all the functions and key inputs of the contents reproducing apparatus 100 can be used. In the simplified function mode 52, special key operations and the like are made invalid and thus special functions cannot be used. In the simplified operation mode 53, a key input required for reproduction of the disc is automatically made by the reproducing apparatus 100 to eliminate a key input of a user and special key operations and the like are limited, so that special functions cannot be used. In the function customized mode 54, a user can select a desired function from all the functions usable in the reproducing apparatus 100 and the other functions are made unusable (invalid).

The following will specifically describe the case where the operation mode 50 is the simplified operation mode 53 in the reproducing apparatus 100.

To be specific, the control unit 101 performs data analysis on contents, some of originally required operations are performed according to a decision of the control unit 101 based on the analysis results, and thus user's key inputs for the operations are eliminated.

For example, when the disc 107 is loaded into the disc tray 40 to start reproduction and menu contents are reproduced, a user has to provide the reproducing apparatus 100 with the subsequent instruction through a key operation. When the operation mode 50 is the simplified operation mode 53, the reproducing apparatus 100 decides that the user has performed an operation to start reproducing a main part (the body of contents to be reproduced). Thus even if the user does not provide the reproducing apparatus 100 with the subsequent instruction through a key operation, the reproduction of the main part is started.

For example, in the case where the disc 107 for a plurality of languages is reproduced in the reproducing apparatus 100, a user selects one of the languages for reproducing the disc 107. When the operation mode 50 is the simplified operation mode 53, reproduction is performed based on a language set in the first storage section 103.

Further, the user makes a selection setting and the like of audio data on the disc 107. When the operation mode 50 is the simplified operation mode 53 for eliminating complicated operations, a set value stored in the first storage section 103 is used in the reproducing apparatus 100.

The selection setting on the disc 107 is not limited to the above. The user can also set the detail other than the video data and audio data of the reproducing apparatus 100. Further, when the operation mode 50 is the simplified operation mode 53, the set value stored in the first storage section 103 can be used as the set value of the reproducing apparatus 100.

Referring to FIGS. 4 to 7, a content reproducing method will be described below.

FIG. 4 is a flowchart showing a method of determining the presence or absence of menu contents obtained by using data read from a disc.

When the disc 107 is loaded into the disc tray 40 of the reproducing apparatus 100, data is read from the disc 107 (S001).

It is decided whether the read data includes VMGM_VOBS (VOBS for a menu) (S002). When VMGM_VOBS is included, it is decided that menu contents are “present” (S004).

When the read data does not include VMGM_VOBS (VOBS for the menu) (S002) but includes VTSM_VOBS (VOBS for the menu) (S003), it is decided that menu contents are “present” (S004).

When the read data includes neither VMGM_VOBS (VOBS for the menu) (S002) nor VTSM_VOBS (VOBS for the menu) (S003), it is decided that menu contents are “absent” (S005).

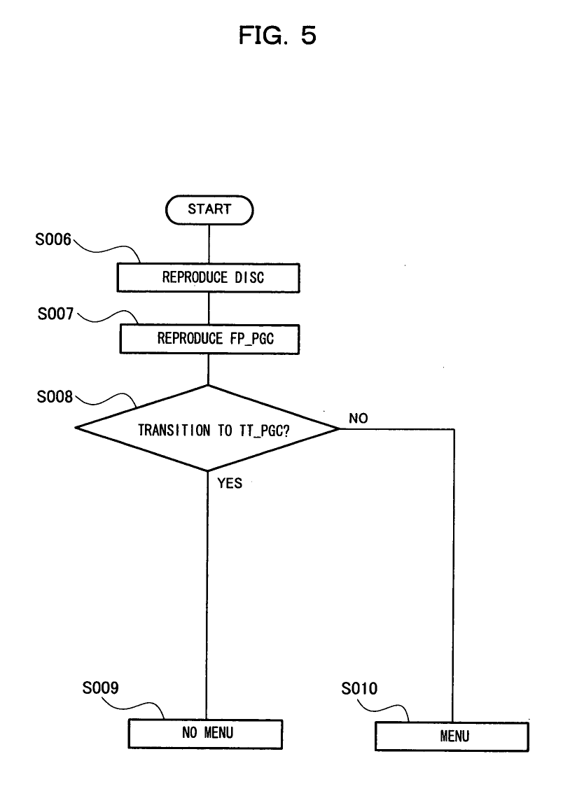

FIG. 5 is a flowchart showing a method of determining the presence or absence of menu contents during the reproduction of the disc.

When the disc 107 is loaded into the disc tray 40 of the reproducing apparatus 100 to reproduce data (S006), FP_PGC is reproduced (S007), and then the reproduction makes a transition to TT_PGC (S008), it is decided that menu contents are “absent” (S009). When the reproduction makes a transition to another PGC (S008), it is decided that menu contents are “present” (S010).

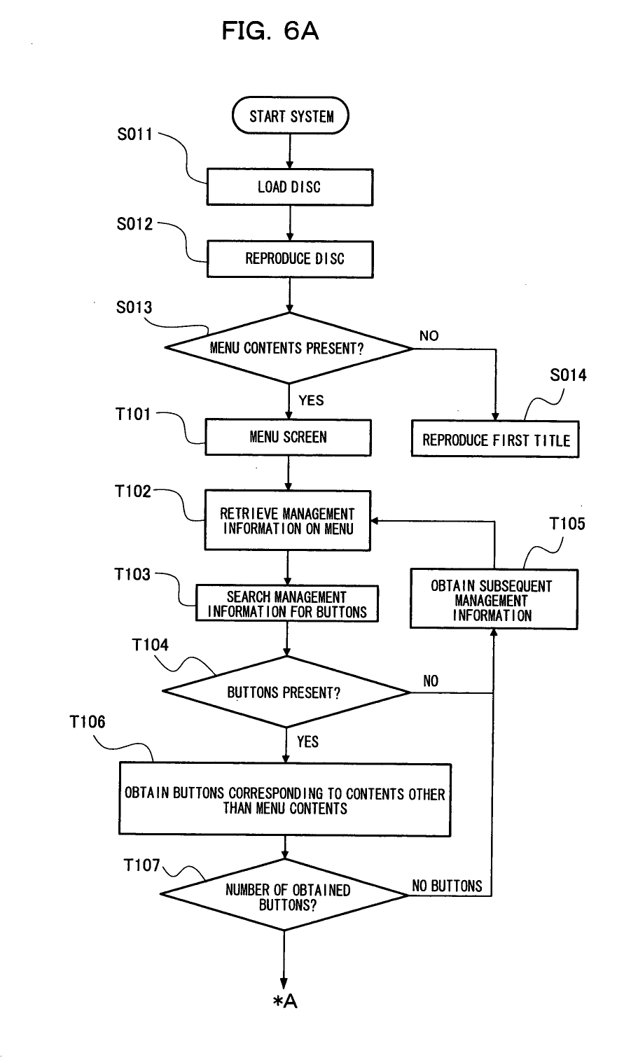

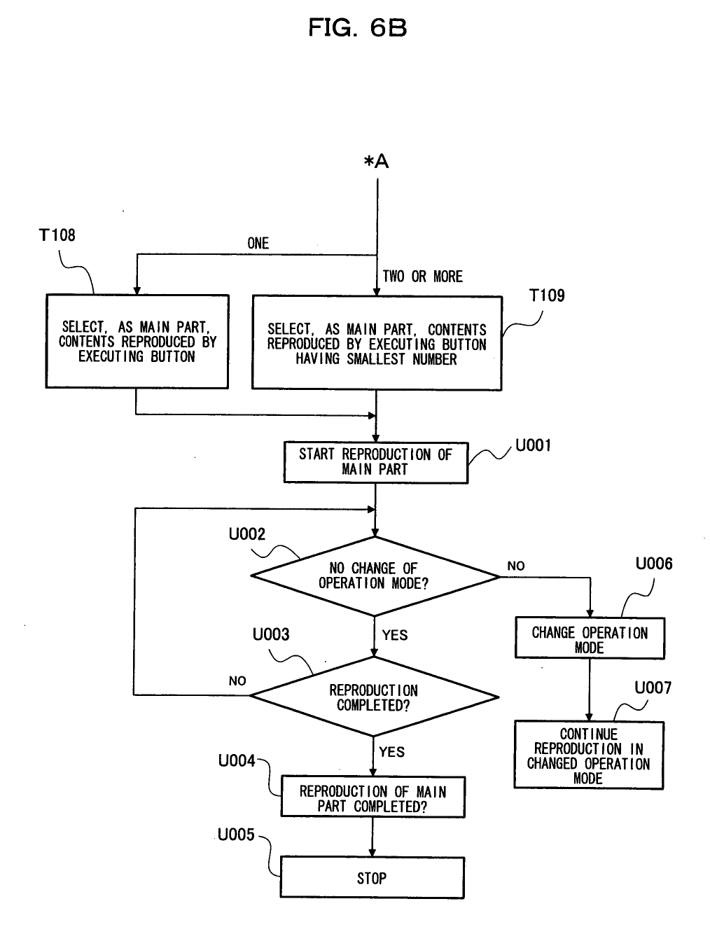

FIGS. 6A and 6B are flowcharts showing operations performed when the operation mode 50 of the reproducing apparatus 100 is the simplified operation mode 53. Operations to be performed by a user on menu contents are eliminated and the main part of contents is selected and reproduced by the reproducing apparatus 100 according to the contents recorded on the disc 107. FIGS. 6A and 6B show the flowcharts divided from a single flowchart. “*A” in FIG. 6A is connected to “*A” in FIG. 6B.

When the disc 107 is loaded into the disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T101) and management information on a reproduced menu is retrieved (T102). For example, in the DVD-Video standard, HLI_GI of NV_PCK is retrieved.

Next, the management information is searched for buttons (T103) and it is decided whether buttons are present or not (T104). When buttons are absent, the reproducing apparatus 100 waits for a change of the reproduced menu management information. In other words, the subsequent management information (HLI_GI of NV_PCK) is obtained (T105).

When buttons are present (T104), buttons for reproducing video data including contents other than menu contents are obtained (T106). The video data is reproduced when the obtained buttons are executed (or after the obtained buttons are executed).

The number of obtained buttons is decided (T107).

When buttons are absent, the subsequent management information (HLI_GI of NV_PCK) is obtained (T105) as in the above description.

When only one button is obtained, contents reproduced by executing the button are selected as a main part (T108).

When a plurality of (two or more) buttons are obtained, contents reproduced by one button having the smallest number are selected as a main part (T109). The number can uniquely distinguish (identify) the one button from the other buttons.

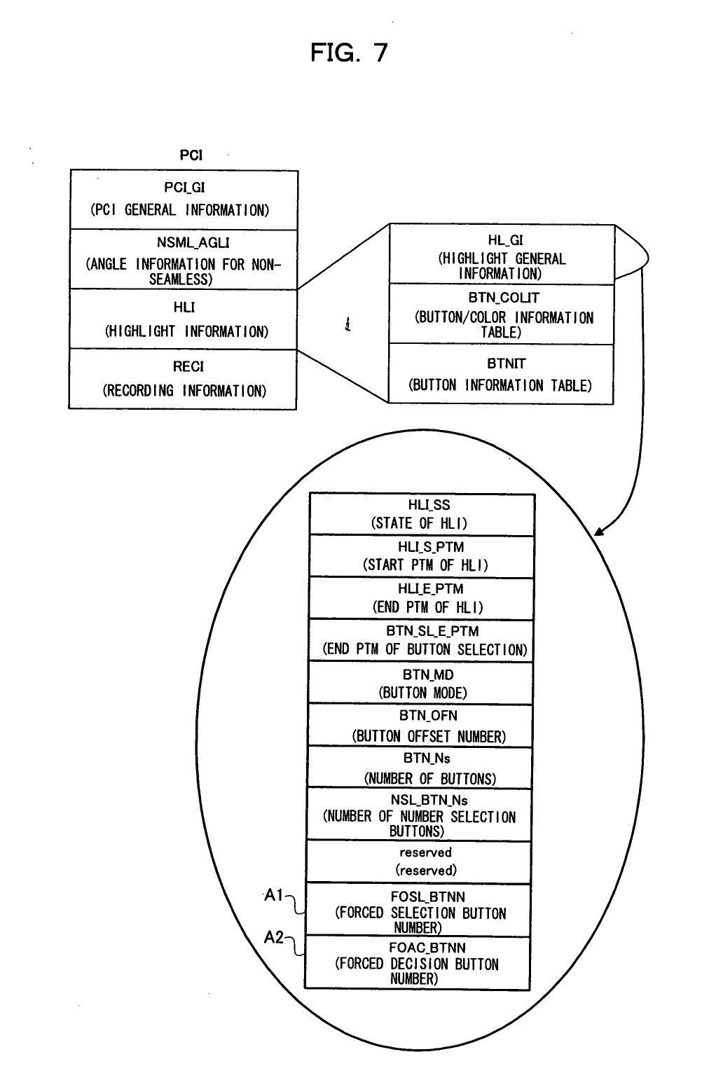

FIG. 7 shows a location for storing button information.

For example, according to management information PCI in the DVD-Video standard, a button where a cursor is first placed on the display can be decided from A1 information shown in FIG. 7 and a button forcibly executed after a certain period of time can be decided from A2 information shown in FIG. 7. PCI is a proper name of management information defined by the DVD-Video standard and has one-to-one correspondence with reproduced video data.

And then, the reproduction of the selected main part is started (U001).

Next, when the operation mode is not to be changed during the reproduction of the main part (U002), at the completion of the reproduction of the main part (U003), the reproduction of the main part is ended (U004) and the reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

In the above description, the reproducing apparatus 100 is stopped after the completion of the reproduction of the main part (U005). For example, instead of stopping the reproducing apparatus, the menu may be displayed or the tray may be opened.

According to the configuration of First Embodiment, a user can select a usable key in response to the operation mode and the control unit can determine a usable key according to contents. Thus it is possible to perform, for example, key operations corresponding to the skill of the user, improving convenience.

Further, an operation mode can be automatically switched at a midpoint of the mode to the most suitable operation mode, so that a proper operation can be performed in response to an operating state of equipment.

Moreover, in the simplified operation mode, contents are read from a recording medium to decide the presence or absence of menu contents or analyze the title of the body of the contents, and some of necessary key operations are automatically performed according to the contents to reproduce the contents. At this point, even in the presence of the menu contents and the subsequent menu contents, regarding buttons corresponding to contents other than the subsequent menu contents, the contents of the buttons are automatically reproduced as a main part. Thus even when the menu has at least two stages, the body of the contents can be reliably reproduced.

When a plurality of buttons are provided to reproduce contents other than the menu contents, contents corresponding to one button having the smallest number are reproduced. Thus, for example, as compared with a search of the body of contents based on the duration of the reproduction of the contents, it is possible to more reliably search the body of the contents.

In First Embodiment, when a main part is retrieved, it is first decided whether the initial menu includes buttons or not and buttons for reproducing contents other than menu contents during the execution of the buttons are obtained. The number of buttons is one or more. Variations for identifying a main part will be described below in accordance with Second to Sixth Embodiments.

In the following embodiments, steps (reproduction method) in a flow different from that of First Embodiment will be mainly described. The constituent elements are indicated by the same reference numerals as those of First Embodiment, and steps before and after the identification of a main part (numbered with S and U) are indicated by the same step numbers.

### Second Embodiment

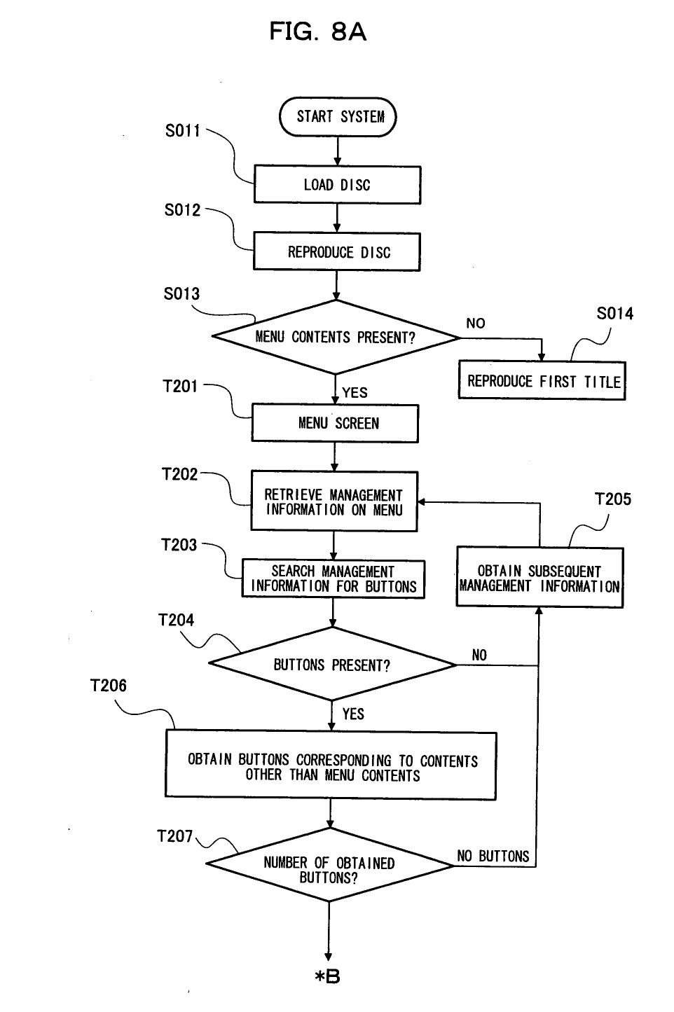

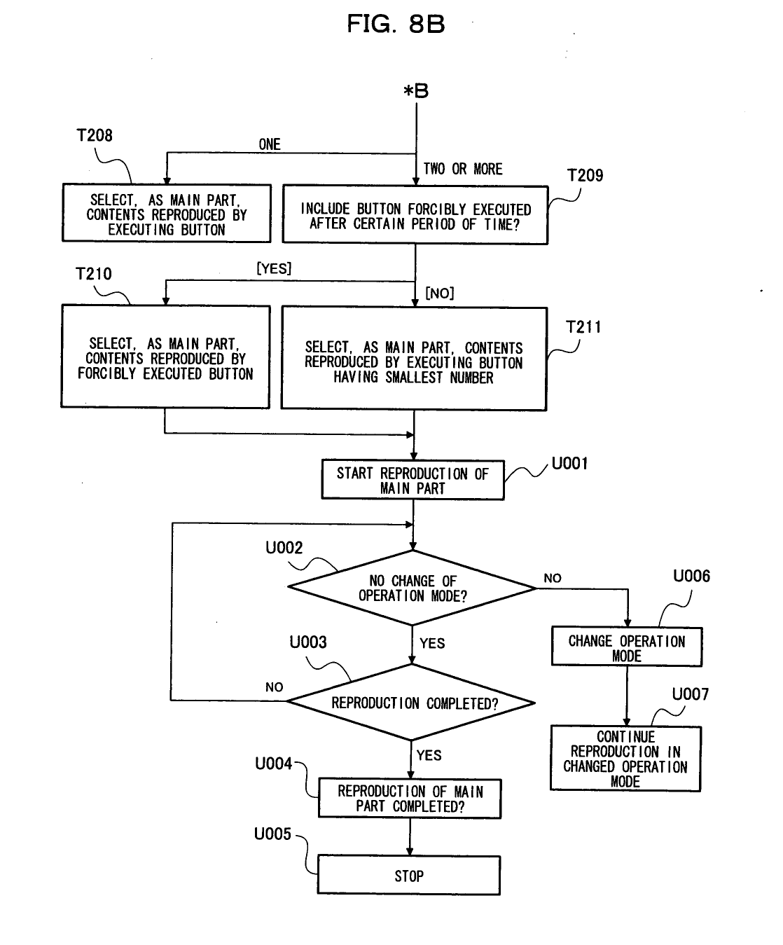

A content reproducing method according to Second Embodiment of the present invention will be described below with reference to the flowcharts of FIGS. 8A and 8B (corresponding to claim 3). FIGS. 8A and 8B show the flowcharts divided from a single flowchart. “*B” in FIG. 8A is connected to “*B” in FIG. 8B.

When a disc 107 is loaded into a disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T201) and management information on a reproduced menu is retrieved (T202). For example, in the DVD-Video standard, HLI_GI of NV_PCK is retrieved.

Next, the management information is searched for buttons (T203) and it is decided whether buttons are present or not (T204). When buttons are absent, a reproducing apparatus 100 waits for a change of the reproduced menu management information. In other words, the subsequent management information (HLI_GI of NV_PCK) is obtained (T205).

When buttons are present (T204), buttons for reproducing video data including contents other than menu contents are obtained (T206). The video data is reproduced when the obtained buttons are executed (or after the obtained buttons are executed).

The number of obtained buttons is decided (T207).

When buttons are absent, the subsequent management information (HLI_GI of NV_PCK) is obtained (T205) as in the above description.

When only one button is obtained, contents reproduced by executing the button are selected as a main part (T208).

When a plurality of (two or more) buttons are obtained, it is decided whether or not the buttons include a button forcibly executed after a certain period of time (T209). When the buttons include the button forcibly executed after a certain period of time, contents reproduced by executing the button are selected as a main part (T210).

When the buttons do not include the button forcibly executed after a certain period of time, contents reproduced by one button having the smallest number are selected as a main part (T211) out of numbers uniquely distinguishing (identifying) the respective buttons.

FIG. 7 shows a location for storing button information.

And then, the reproduction of the selected main part is started (U001).

Next, when an operation mode is not to be changed during the reproduction of the main part (U002), at the completion of the reproduction of the main part (U003), the reproduction of the main part is ended (U004) and the reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

According to the configuration of Second Embodiment, substantially like the effect of First Embodiment, when a plurality of buttons are provided to reproduce contents other than menu contents, contents corresponding to one button executed after a certain period of time are reproduced. Thus, for example, as compared with a search of the body of contents based on the duration of the reproduction of the contents, it is possible to more reliably search the body of the contents.

### Third Embodiment

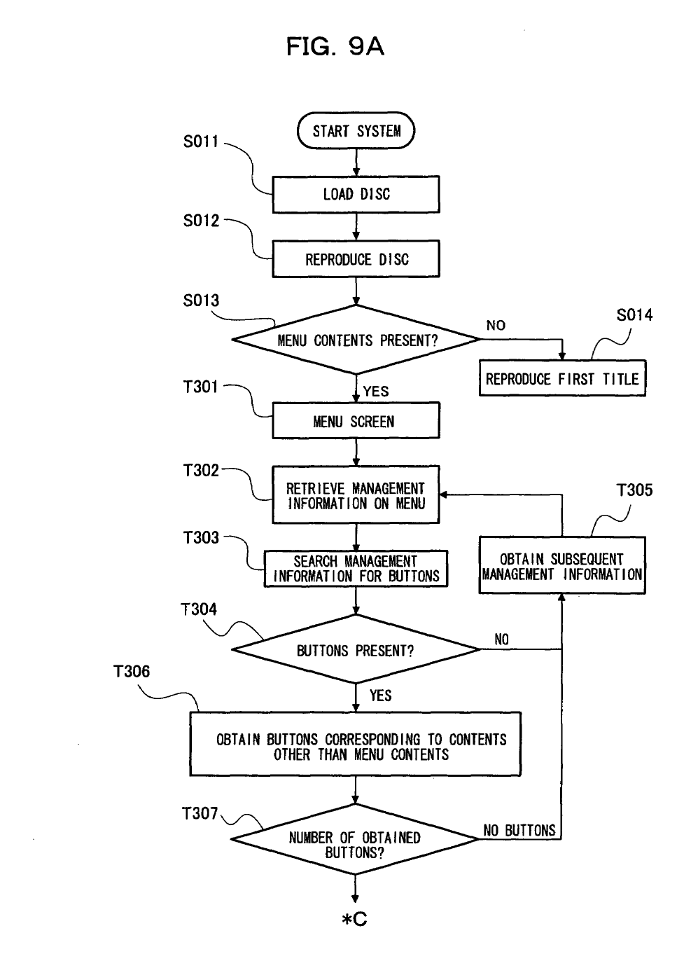

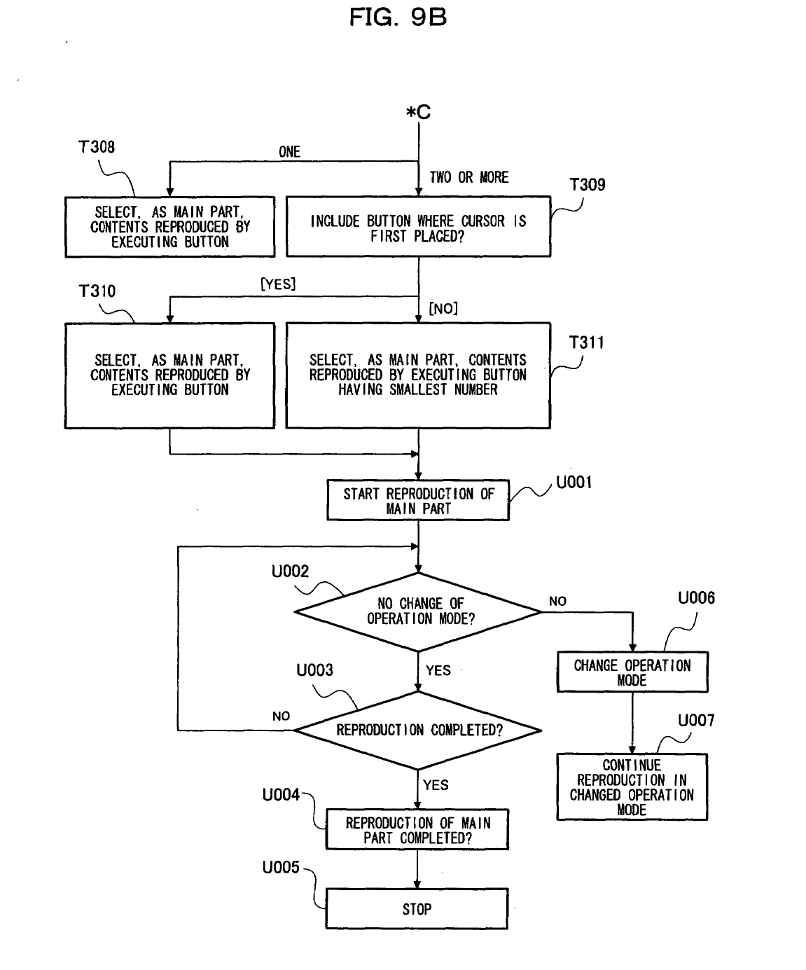

A content reproducing method according to Third Embodiment of the present invention will be described below with reference to the flowcharts of FIGS. 9A and 9B (corresponding to claim 4). FIGS. 9A and 9B show the flowcharts divided from a single flowchart. “*C” in FIG. 9A is connected to “*C” in FIG. 9B.

When a disc 107 is loaded into a disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T301) and management information on a reproduced menu is retrieved (T302). For example, in the DVD-Video standard, HLI_GI of NV_PCK is retrieved.

Next, the management information is searched for buttons (T303) and it is decided whether buttons are present or not (T304). When buttons are absent, a reproducing apparatus 100 waits for a change of the reproduced menu management information. In other words, when buttons are absent, the subsequent management information (HLI_GI of NV_PCK) is obtained (T305).

When buttons are present (T304), buttons for reproducing video data including contents other than menu contents are obtained (T306). The video data is reproduced when the obtained buttons are executed (or after the obtained buttons are executed).

The number of obtained buttons is decided (T307).

When buttons are absent, the subsequent management information (HLI_GI of NV_PCK) is obtained (T305) as in the above description.

When only one button is obtained, contents reproduced by executing the button are selected as a main part (T308).

When a plurality of (two or more) buttons are obtained, it is decided whether or not the buttons include a button where a cursor is first placed on the display (T309). When the buttons include a button where the cursor is placed, contents reproduced by executing the button are selected as a main part (T310).

When the buttons do not include any buttons where the cursor is placed, contents reproduced by executing one button having the smallest number are selected as a main part (T311) out of numbers uniquely distinguishing (identifying) the respective buttons.

FIG. 7 shows a location for storing button information.

And then, the reproduction of the selected main part is started (U001).

Next, when the operation mode is not to be changed during the reproduction of the main part (U002), at the completion of the reproduction of the main part (U003), the reproduction of the main part is ended (U004) and the reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

According to the configuration of Third Embodiment, substantially like the effect of First Embodiment, when a plurality of buttons are provided to reproduce contents other than menu contents, contents corresponding to one button where a cursor is first placed are reproduced. Thus, for example, as compared with a search of the body of contents based on the duration of the reproduction of the contents, it is possible to more reliably search the body of the contents.

### Fourth Embodiment

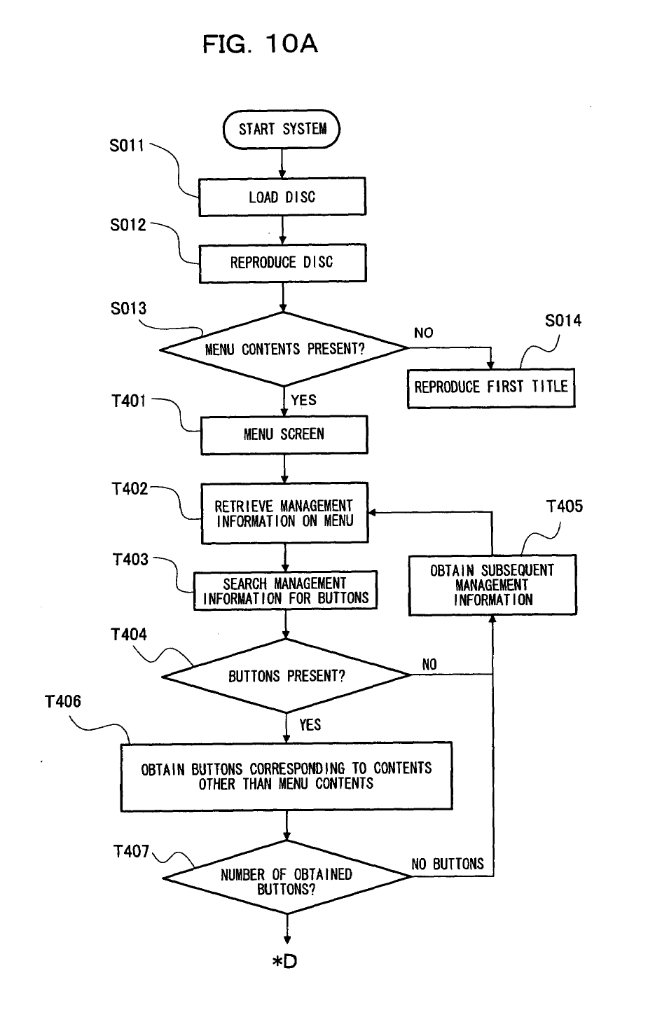

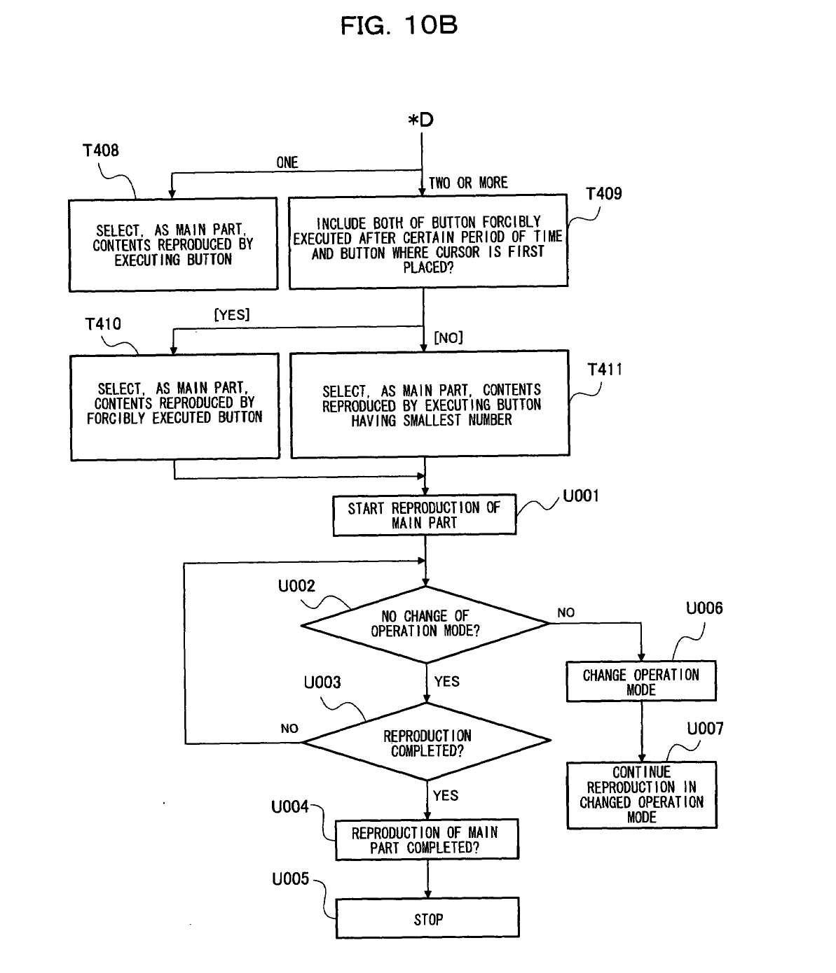

A content reproducing method according to Fourth Embodiment of the present invention will be described below with reference to the flowcharts of FIGS. 10A and 10B (corresponding to claim 5). FIGS. 10A and 10B show the flowcharts divided from a single flowchart. “*D” in FIG. 10A is connected to “*D” in FIG. 10B.

When a disc 107 is loaded into a disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T401) and management information on a reproduced menu is retrieved (T402). For example, in the DVD-Video standard, HLI_GI of NV_PCK is retrieved.

Next, the management information is searched for buttons (T403) and it is decided whether buttons are present or not (T404). When buttons are absent, a reproducing apparatus 100 waits for a change of the reproduced menu management information. In other words, when buttons are absent, the subsequent management information (HLI_GI of NV_PCK) is obtained (T405).

When buttons are present (T404), buttons for reproducing video data including contents other than menu contents are obtained (T406). The video data is reproduced when the obtained buttons are executed (or after the obtained buttons are executed).

The number of obtained buttons is decided (T407).

When buttons are absent, the subsequent management information (HLI_GI of NV_PCK) is obtained as in the above description (T405).

When only one button is obtained, contents reproduced by executing the button are selected as a main part (T408).

When a plurality of (two or more) buttons are obtained, it is decided whether or not the buttons include a button forcibly executed after a certain period of time and a button where a cursor is first placed (T409).

When it is decided that both of the buttons are included, contents reproduced by executing the button forcibly executed after a certain period of time are selected as a main part (T410).

When the buttons are not included together, contents reproduced by one button having the smallest number are selected as a main part (T411) out of numbers uniquely distinguishing (identifying) the respective buttons.

FIG. 7 shows a location for storing button information.

And then, the reproduction of the selected main part is started (U001).

Next, when the operation mode is not to be changed during the reproduction of the main part (U002), at the completion of the reproduction of the main part (U003), the reproduction of the main part is ended (U004) and the reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

According to the configuration of Fourth Embodiment, substantially like the effect of First Embodiment, when a plurality of buttons are provided to reproduce contents other than menu contents and the buttons include a button where a cursor is first placed and a button executed after a certain period of time, contents corresponding to the button executed after a certain period of time are reproduced. Thus, for example, as compared with a search of the body of contents based on the duration of the reproduction of the contents, it is possible to more reliably search the body of the contents.

### Fifth Embodiment

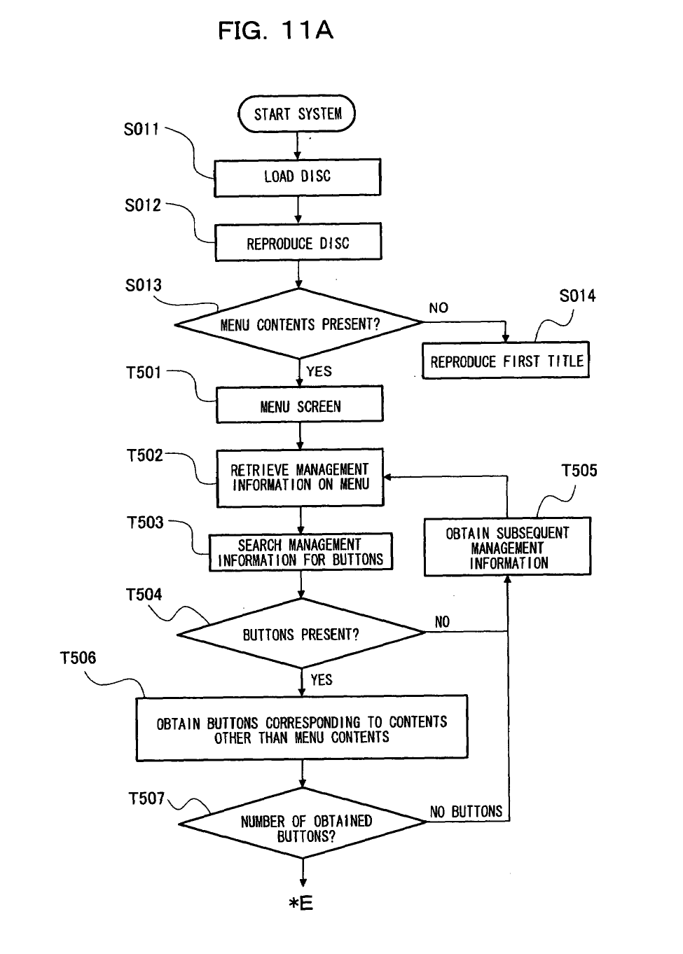

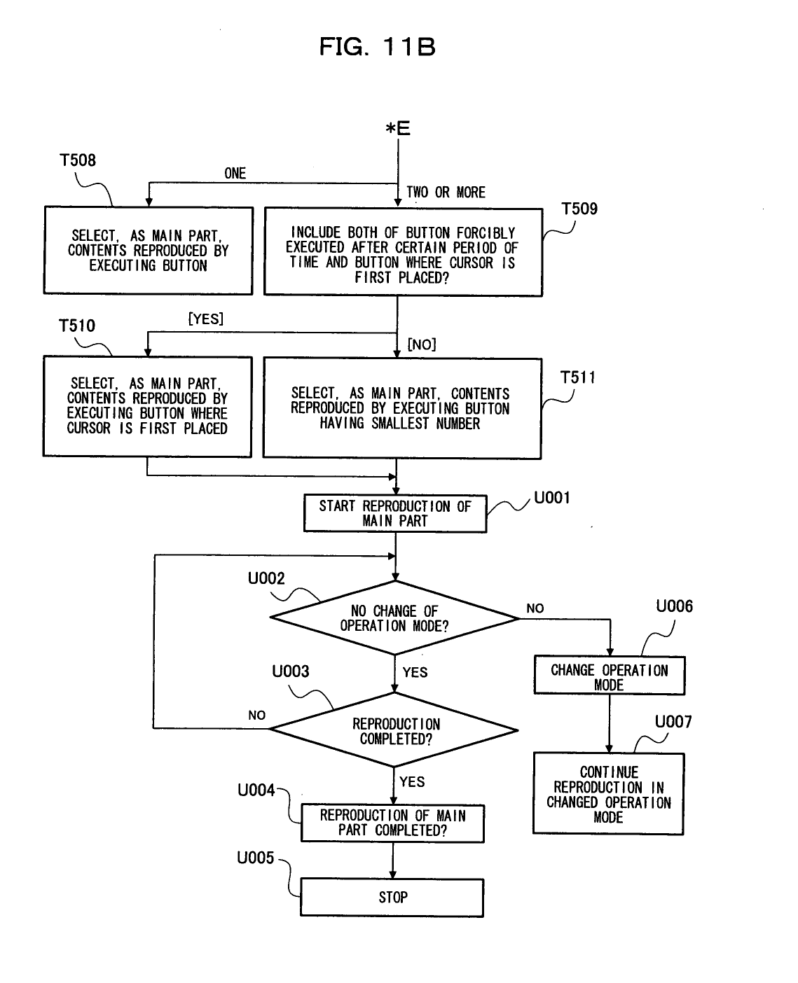

A content reproducing method according to Fifth Embodiment of the present invention will be described below with reference to the flowcharts of FIGS. 11A and 11B (corresponding to claims 6 and 7). FIGS. 11A and 11B show the flowcharts divided from a single flowchart. “*E” in FIG. 11A is connected to “*E” in FIG. 11B.

When a disc 107 is loaded into a disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T501) and management information on a reproduced menu is retrieved (T502). For example, in the DVD-Video standard, HLI_GI of NV_PCK is retrieved.

Next, the management information is searched for buttons (T503) and it is decided whether the buttons are present or not (T504). When buttons are absent, a reproducing apparatus 100 waits for a change of the reproduced menu management information. In other words, when buttons absent, the subsequent management information (HLI_GI of NV_PCK) is obtained (T505).

When buttons are present (T504), buttons for reproducing video data including contents other than menu contents are obtained (T506). The video data is reproduced when the obtained buttons are executed (or after the obtained buttons are executed).

The number of obtained buttons is decided (T507).

When buttons are absent, the subsequent management information (HLI_GI of NV_PCK) is obtained (T505) as in the above description.

When only one button is obtained, contents reproduced by executing the button are selected as a main part (T508).

When a plurality of (two or more) buttons are obtained, it is decided whether or not the buttons include a button forcibly executed after a certain period of time and a button where a cursor is first placed (T509).

When both of the buttons are included, contents reproduced by executing the button where the cursor is first placed are selected as a main part (T510).

When both of the buttons are not included, contents reproduced by one button having the smallest number are selected as a main part (T511) out of numbers uniquely distinguishing (identifying) the respective buttons.

FIG. 7 shows a location for storing button information.

And then, the reproduction of the selected main part is started (U001).

Next, when the operation mode is not to be changed during the reproduction of the main part (U002), at the completion of the reproduction of the main part (U003), the reproduction of the main part is ended (U004) and the reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

According to the configuration of Fifth Embodiment, substantially like the effect of First Embodiment, when a plurality of buttons are provided to reproduce contents other than menu contents and the buttons include a button where a cursor is first placed and a button executed after a certain period of time, contents corresponding to the button where the cursor is first placed are reproduced. Further, in the absence of the button where the cursor is first placed and the button executed after a certain period of time, contents corresponding to the button uniquely distinguishable from the other buttons with the smallest number are reproduced. Thus, for example, as compared with a search of the body of contents based on the duration of the reproduction of the contents, it is possible to more reliably search the body of the contents.

In step (T410) of Fourth Embodiment, when it is decided that both of the buttons are included, contents reproduced by the button forcibly executed after a certain period of time are selected as a main part. In step (T510) of Fifth Embodiment, when it is decided that both of the buttons are included, contents reproduced by executing the button where the cursor is first placed are selected as a main part. In brief, the button for reproducing contents as a main part can be set beforehand. Moreover, when one of the buttons is included, contents reproduced by executing the included button may be selected as a main part.

### Sixth Embodiment

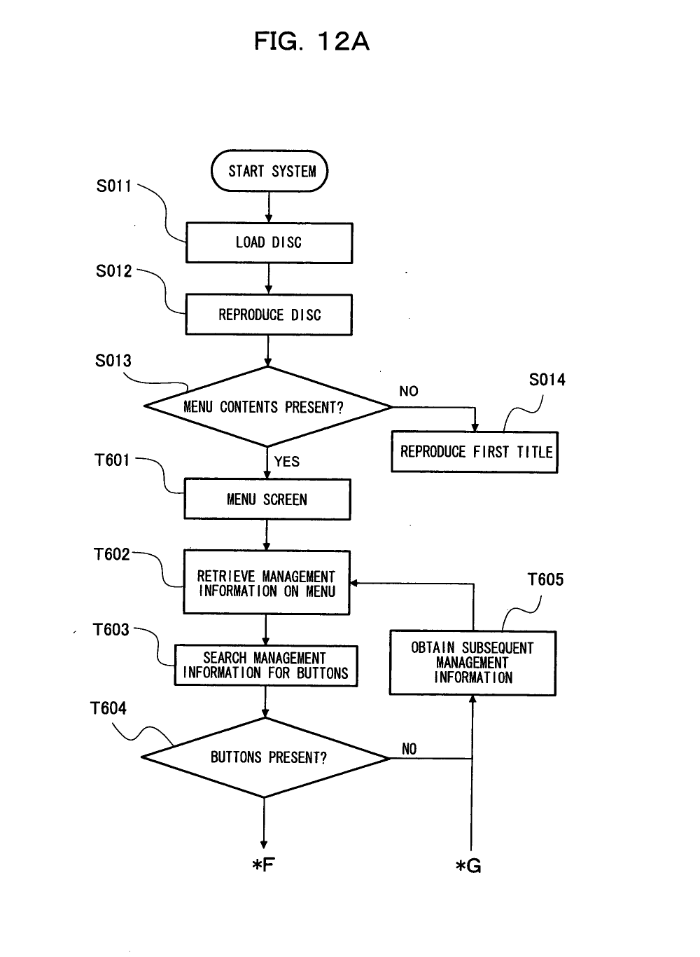

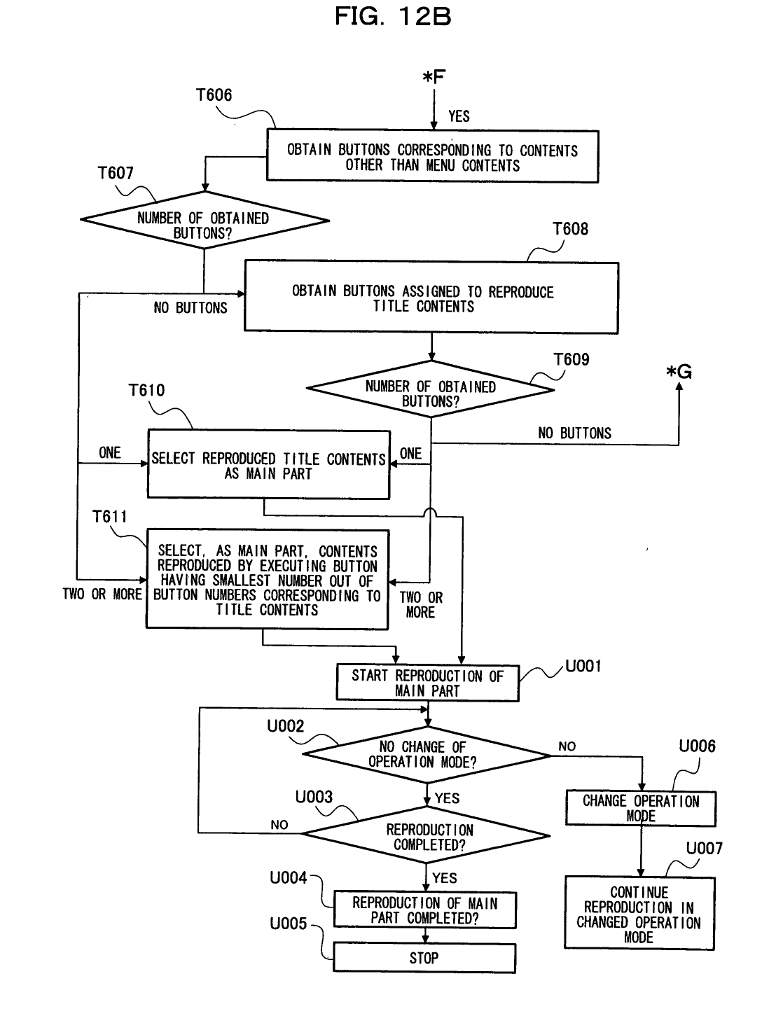

A content reproducing method according to Sixth Embodiment of the present invention will be described below with reference to the flowcharts of FIGS. 12A and 12B (corresponding to claim 8). FIGS. 12A and 12B show the flowcharts divided from a single flowchart. “*F” and “*G” in FIG. 12A are connected to “*F” and “*G” in FIG. 12B.

When a disc 107 is loaded into a disc tray 40 (S011), the reproduction of the disc 107 is started (S012) and the disc 107 is searched for menu contents (S013). When menu contents are absent, the first title is reproduced (S014).

When menu contents are present, a transition takes place to a menu screen (T601) and management information on a reproduced menu is retrieved (T602). For example, in the DVD-Video standard, HLI_GI of NV_PCK is retrieved.

Next, the management information is searched for buttons (T603) and it is decided whether buttons are present or not (T604). When buttons are absent, a reproducing apparatus 100 waits for a change of the reproduced menu management information. In other words, when buttons are absent, the subsequent management information (HLI_GI of NV_PCK) is obtained (T605).

When buttons are present (T604), buttons for reproducing video data including contents other than menu contents are obtained (T606). The video data is reproduced when the obtained buttons are executed (or after the obtained buttons are executed).

The number of obtained buttons is decided (T607).

When buttons are absent, that is, when contents reproduced by pressing the buttons are all menu contents, buttons assigned to reproduce title contents without user operations are obtained (T608) after the menu contents are reproduced by pressing the buttons.

The number of buttons assigned to reproduce title contents is decided (T609).

When such buttons are absent, the process advances to step T605 and the subsequent management information (HLI_GI of NV_PCK) is obtained.

Next, when the number of buttons obtained in step 607 or 609 is one, title contents executed thereafter are selected as a main part without user operations after the menu contents are reproduced (T610).

Next, when the number of buttons obtained in step 607 or 609 is two or more, contents reproduced by one button having the smallest number are selected as a main part without user operations after the menu contents are reproduced (T611), out of numbers uniquely distinguishing (identifying) the respective buttons corresponding to title contents executed thereafter.

FIG. 7 shows a location for storing button information.

And then, the reproduction of the selected main part is started (U001).

Next, when the operation mode is not to be changed during the reproduction of the main part (U002), at the completion of the reproduction of the main part (U003), the reproduction of the main part is ended (U004) and a reproducing apparatus 100 is stopped (U005). When the reproduction of the main part is not completed (U003), the reproduction of the main part is continued.

When the operation mode is to be changed during the reproduction of the main part (U002), the operation mode is changed (U006) and the reproduction is continued in the changed operation mode (U007).

According to the configuration of Sixth Embodiment, substantially like the effect of First Embodiment, when a plurality of buttons are provided to reproduce contents other than menu contents and contents reproduced by the buttons are all menu contents, contents corresponding to buttons executed without user operations are reproduced. Thus, for example, as compared with a search of the body of contents based on the duration of the reproduction of the contents, it is possible to more reliably search the body of the contents.

In the above explanation, the contents reproducing apparatus is a reproducing apparatus for an optical disc. The recording medium is not limited to an optical disc and the present invention is also applicable to an apparatus for reproducing contents recorded on a recording medium such as a hard disk. For example, the recording medium may be a memory card such as an SD card and a PC card. Further, the present invention is also applicable to other digital equipment, network AV servers, and so on.

What is claimed is:

1. A contents reproducing apparatus having, as operation modes, at least a normal operation mode enabling all operations and a simplified operation mode enabling a control unit to automatically perform key operations required during reproduction, the contents reproducing apparatus eliminating key operations from a body key operation part and a remote key operation part according to a predetermined operation corresponding to the selected operation mode,
when the control unit reads contents from a recording medium, analyzes one of presence or absence of menu contents and a title indicating a body of the contents, and automatically performs some of necessary key operations according to contents of an analysis to reproduce the contents,
menu contents are present and contents corresponding to buttons assigned to reproduce contents other than menu contents are reproduced as a main part when buttons of a menu are pressed.

2. The content reproducing method according to claim 1, wherein when a plurality of buttons are provided to reproduce contents other than menu contents, contents reproduced by executing one button having the smallest number are reproduced as a main part, out of the buttons identified by numbers.

3. The content reproducing method according to claim 1, wherein when a plurality of buttons are provided to reproduce contents other than menu contents, contents reproduced by executing one button automatically executed after a certain period of time are reproduced as a main part.

4. The content reproducing method according to claim 1, wherein when a plurality of buttons are provided to reproduce contents other than menu contents, contents reproduced by executing one button where a cursor is placed upon display of the menu are reproduced as a main part.

5. The content reproducing method according to claim 1, wherein when a plurality of buttons are provided to reproduce contents other than menu contents and the buttons include a button automatically executed after a certain period of time and a button where a cursor is placed upon display of the menu, contents reproduced by executing the button automatically executed after a certain period of time are reproduced as a main part.

6. The content reproducing method according to claim 1, wherein when a plurality of buttons are provided to reproduce contents other than menu contents and the buttons include a button automatically executed after a certain period of time and a button where a cursor is placed upon display of the menu, contents reproduced by executing the button where the cursor is placed upon the display of the menu are reproduced as a main part.

7. The content reproducing method according to claim 1, wherein when a plurality of buttons are provided to reproduce contents other than menu contents and the buttons do not include a button automatically executed after a certain period of time and a button where a cursor is placed upon display of the menu, contents reproduced by executing one button having the smallest number are reproduced as a main part, out of the buttons identified by numbers.

8. A contents reproducing apparatus having, as operation modes, at least a normal operation mode enabling all operations and a simplified operation mode enabling a control unit to automatically perform key operations required during reproduction, the contents reproducing apparatus eliminating key operations from a body key operation part and a remote key operation part according to a predetermined operation corresponding to the selected operation mode,
when the control unit reads contents from a recording medium, analyzes one of presence or absence of menu contents and a title indicating a body of the contents, and automatically performs some of necessary key operations according to contents of an analysis to reproduce the contents,
in the case where menu contents are present and contents reproduced by pressing buttons of a menu are all menu contents, contents corresponding to buttons assigned to reproduce title contents without user operations are reproduced as a main part during reproduction of the menu contents reproduced by pressing the buttons.
